(19) United States
(12) Patent Application Publication
(10) Pub. No.: US 2024/0184847 A1
(43) Pub. Date: Jun. 6, 2024

(54) OPTICAL CIRCUIT BUILDING METHOD, OPTICAL CIRCUIT, AND OPTICAL SIGNAL PROCESSING METHOD AND APPARATUS

(71) Applicant: Inspur Electronic Information Industry Co., Ltd., Jinan (CN)

(72) Inventors: Ruizhen Wu, Shandong (CN); Lin Wang, Shandong (CN)

(73) Assignee: Inspur Electronic Information Industry Co., Ltd., Shandong (CN)

(21) Appl. No.: 18/275,733

(22) PCT Filed: Nov. 30, 2021
(86) PCT No.: PCT/CN2021/134334

§ 371 Date: Aug. 3, 2023

(30) Foreign Application Priority Data
Jul. 29, 2021 (CN) 202110866087.0

(51) Int. Cl. G06F 17/16; G06N 3/045; G06N 3/067

(52) U.S. Cl. CPC G06F 17/16; G06N 3/045; G06N 3/0675

(57) ABSTRACT

An optical circuit building method, an optical circuit, and an optical signal processing method and apparatus, the method comprising: constructing a convolution weight matrix corresponding to multiple groups of convolution weights (S11); performing singular value decomposition on the convolution weight matrix to obtain a first unitary matrix, a diagonal matrix and a second unitary matrix (S12); separately determining a first MZI structure corresponding to the first unitary matrix, a second MZI structure corresponding to the diagonal matrix and a third MZI structure corresponding to the second unitary matrix (S13); and connecting the first MZI structure, the second MZI structure and the third MZI structure to obtain an optical circuit (S14). In an optical circuit obtained by means of the foregoing, convolution calculation processing corresponding to multiple groups of convolution weights may be carried out at the same time, operation depth may be reduced, and operation efficiency may be improved.

### CROSS-REFERENCE TO RELATED APPLICATION

This application claims priority to Chinese Patent Application No. 202110866087.0, filed with the China National Intellectual Property Administration on Jul. 29, 2021 and entitled “OPTICAL CIRCUIT BUILDING METHOD, OPTICAL CIRCUIT, AND OPTICAL SIGNAL PROCESSING METHOD AND APPARATUS”, which is incorporated herein by reference in its entirety.

### TECHNICAL FIELD

This application relates to the field of optical neural network (ONN) technologies, and in particular, to an optical circuit building method, an optical circuit, and an optical signal processing method and apparatus.

### BACKGROUND

A method for implementing optical operation by using a Mach-Zehnder interferometer (MZI) is easily controllable, and is the most used method in industry today, and corresponding implementation of convolution in an MZI-based ONN is a research hotspot. In a real artificial neural network (ANN), for same data to be processed, there are often multiple groups of operation requirements of convolutional weights. Convolution operation in a conventional ANN implements multiply-add operation of weights corresponding to one convolution kernel, that is, implements multiply-add operation corresponding to one group of convolution weights each time. Therefore, for operation requirements of multiple groups of convolution weights, there are problems of a large operation depth and low operation efficiency.

### SUMMARY

In view of this, an objective of the of this application is to provide an optical circuit building method, an optical circuit, and an optical signal processing method and apparatus, so that operation depth may be reduced, and operation efficiency may be improved. Specific solutions of this application are as follows:

According to a first aspect, this application discloses an optical circuit building method, including:
constructing a convolution weight matrix corresponding to multiple groups of convolution weights;
performing singular value decomposition (SVD) on the convolution weight matrix to obtain a first unitary matrix, a diagonal matrix and a second unitary matrix;
separately determining a first MZI structure corresponding to the first unitary matrix, a second MZI structure corresponding to the diagonal matrix and a third MZI structure corresponding to the second unitary matrix; and
connecting the first MZI structure, the second MZI structure and the third MZI structure to obtain an optical circuit.

In one embodiment of the present application, the step of constructing a convolution weight matrix corresponding to multiple groups of convolution weights includes:
constructing the convolution weight matrix by using each group of convolution weights as each row data of the convolution weight matrix, where each column data of the convolution weight matrix corresponds to a corresponding row data in a convolution multiplicand sequence.

In one embodiment of the present application, the step of determining a first MZI structure corresponding to the first unitary matrix includes:
constructing a corresponding elimination matrix based on an MZI minimum multiply-add unit, and performing Gaussian elimination on the first unitary matrix by using the elimination matrix to obtain a diagonal matrix corresponding to the first unitary matrix; and
determining the first MZI structure corresponding to the first unitary matrix based on the elimination matrix.

In one embodiment of the present application, the MZI minimum multiply-add unit is:

$$R = [ \begin{matrix}cos θ & - sin θ \\ sin θ & cos θ\end{matrix} ] ;$$

where 20 is an MZI phase shift angle.

In one embodiment of the present application, on condition that any group of convolution weights are weights corresponding to 2×2 convolution and a quantity of groups is 4, the step of constructing a corresponding elimination matrix based on an MZI minimum multiply-add unit includes:
sequentially constructing elimination matrices R_{full 1}, R₁, R_{full 2}, and R₂ based on the MZI minimum multiply-add unit, where

$${R}_{full 1} = [ \begin{matrix}cos {θ}_{14} & 0 & 0 & - sin {θ}_{14} \\ 0 & cos {θ}_{23} & - s in {θ}_{23} & 0 \\ 0 & sin {θ}_{23} & cos {θ}_{23} & 0 \\ sin {θ}_{14} & 0 & 0 & cos {θ}_{14}\end{matrix} ] ;$$

$${R}_{1} = [ \begin{matrix}cos {θ}_{12} & - sin {θ}_{12} & 0 & 0 \\ sin {θ}_{12} & cos {θ}_{12} & 0 & 0 \\ 0 & o & 1 & 0 \\ 0 & o & 0 & 1\end{matrix} ] ;$$

$${R}_{full 2} = [ \begin{matrix}cos {θ}_{13} & 0 & - sin {θ}_{13} & 0 \\ o & cos {θ}_{24} & 0 & - sin {θ}_{24} \\ sin {θ}_{13} & 0 & cos {θ}_{13} & 0 \\ o & sin {θ}_{24} & 0 & cos {θ}_{24}\end{matrix} ] ;$$

$${R}_{2} = [ \begin{matrix}1 & 0 & 0 & 0 \\ 0 & 1 & 0 & 0 \\ 0 & 0 & cos {θ}_{31} & - s in {θ}_{34} \\ 0 & 0 & sin {θ}_{34} & cos {θ}_{34}\end{matrix} ] ;$$

where a subscript 14 of θ₁₄ represents that an input of a corresponding MZI is a first path signal and a fourth path signal corresponding to a convolution multiplicand sequence, a subscript 23 of θ₂₃ represents that an input of a corresponding MZI is a second path signal and a third path signal corresponding to the convolution multiplicand sequence, a subscript 12 of θ₁₂ represents that an input of a corresponding MZI is a first path signal and a second path signal outputted by an MZI structure corresponding to R_{full 1}, a subscript 13 of θ₁₃ represents that an input of a corresponding MZI is a first path signal and a third path signal outputted by an MZI structure corresponding to R₁, a subscript 24 of θ₂₄ represents that an input of a corresponding MZI is a second path signal and a fourth path signal outputted by an MZI structure corresponding to R₁, and a subscript 34 of θ₃₄ represents that an input of a corresponding MZI is a third path signal and a fourth path signal outputted by an MZI structure corresponding to R_{full 2}.

According to a second aspect, this application discloses an optical circuit. The optical circuit is built by using the foregoing optical circuit building method, and includes:
a first MZI structure configured to connect to an optical signal;
a second MZI structure connected to the first MZI structure; and
a third MZI structure connected to the second MZI structure, where
the first MZI structure, the second MZI structure and the third MZI structure separately perform phase shifting on their respective input signals, to perform convolution calculation processing corresponding to multiple groups of convolution weights in parallel;
the third MZI structure outputs an optical signal after convolution processing; and
the first MZI structure is an MZI structure corresponding to a first unitary matrix, the second MZI structure is an MZI structure corresponding to a diagonal matrix, the third MZI structure is an MZI structure corresponding to a second unitary matrix, the first unitary matrix, the diagonal matrix and the second unitary matrix are matrices obtained by performing SVD on a convolution weight matrix, and the convolution weight matrix is a weight matrix corresponding to the multiple groups of convolution weights.

According to a third aspect, this application discloses an optical signal processing method, including:
obtaining a target convolution multiplicand sequence;
converting the target convolution multiplicand sequence into an optical signal;
performing convolution calculation processing corresponding to multiple groups of convolution weights on the optical signal in parallel by using the foregoing optical circuit to obtain an optical signal after convolution processing; and
performing optical-to-electrical conversion on the optical signal after convolution processing to obtain a convolution calculation result.

In one embodiment of the present application, the apparatus further includes:
determining all phase shift angle configuration values in the optical circuit based on a convolution weight matrix corresponding to current multiple groups of convolution weights; and
configuring the optical circuit by using the phase shift angle configuration values.

According to a fourth aspect, this application discloses an optical signal processing apparatus, including:
a multiplicand sequence obtaining module, configured to obtain a target convolution multiplicand sequence;
an optical signal conversion module, configured to convert the target convolution multiplicand sequence into an optical signal;
an optical convolution processing module, configured to perform convolution calculation processing corresponding to multiple groups of convolution weights on the optical signal in parallel by using the foregoing optical circuit to obtain an optical signal after convolution processing; and
an optical-to-electrical conversion module, configured to perform optical-to-electrical conversion on the optical signal after convolution processing to obtain a convolution calculation result.

According to a fifth aspect, this application discloses a readable storage medium, configured to store a computer program, where the computer program, when executed by a processor, implements steps in the foregoing optical signal processing method.

As can be seen, in this application, a convolution weight matrix corresponding to multiple groups of convolution weights is constructed. Subsequently, SVD is performed on the convolution weight matrix to obtain a first unitary matrix, a diagonal matrix and a second unitary matrix. Then, a first MZI structure corresponding to the first unitary matrix, a second MZI structure corresponding to the diagonal matrix and a third MZI structure corresponding to the second unitary matrix are separately determined. Finally, the first MZI structure, the second MZI structure and the third MZI structure are connected to obtain an optical circuit. That is, in this application, a convolution weight matrix corresponding to multiple groups of convolution weights is first decomposed to obtain two unitary matrices and one diagonal matrix. Subsequently, MZI structures corresponding to the two unitary matrices and the one diagonal matrix are determined. Finally, the MZI structures are connected to obtain an optical circuit. In an optical circuit obtained by means of the foregoing, convolution calculation processing corresponding to multiple groups of convolution weights may be carried out at the same time, operation depth may be reduced, and operation efficiency may be improved.

### BRIEF DESCRIPTION OF DRAWINGS

To describe the technical solutions in the embodiments of this application or the prior art more clearly, the following briefly introduces the accompanying drawings required for describing the embodiments or the prior art. Apparently, the accompanying drawings in the following description show merely embodiments of this application, and a person of ordinary skill in the art may still derive other drawings from the provided accompanying drawings without creative efforts.

FIG. 1 is a flowchart of an optical circuit building method according to this application;

FIG. 2 is a schematic diagram of a specific MZI structure according to this application;

FIG. 3 is a schematic diagram of a specific second MZI structure according to this application;

FIG. 4 is a schematic diagram of an MZI structure corresponding to a specific unitary matrix according to this application;

FIG. 5 is a schematic diagram of a specific optical circuit according to this application;

FIG. 6 is a schematic diagram of an optical circuit according to this application;

FIG. 7 is a flowchart of an optical signal processing method according to this application; and

FIG. 8 is a structural diagram of an optical signal processing apparatus according to this application.

### DESCRIPTION OF EMBODIMENTS

The following clearly and completely describes the technical solutions in embodiments of this application with reference to the accompanying drawings in embodiments of this application. It is clear that the described embodiments are merely some but not all of embodiments of this application. All other embodiments obtained by a person of ordinary skill in the art based on embodiments of this application without creative efforts shall fall within the protection scope of this application.

Currently, in a real ANN, for same data to be processed, there are often multiple groups of operation requirements of convolutional weights. Convolution operation in a conventional ANN implements multiply-add operation of weights corresponding to one convolution kernel, that is, implements multiply-add operation corresponding to one group of convolution weights each time. Therefore, for operation requirements of multiple groups of convolution weights, there are problems of a large operation depth and low operation efficiency. For this, this application provides an optical circuit building method, an optical circuit, and an optical signal processing method and apparatus, so that operation depth may be reduced, and operation efficiency may be improved.

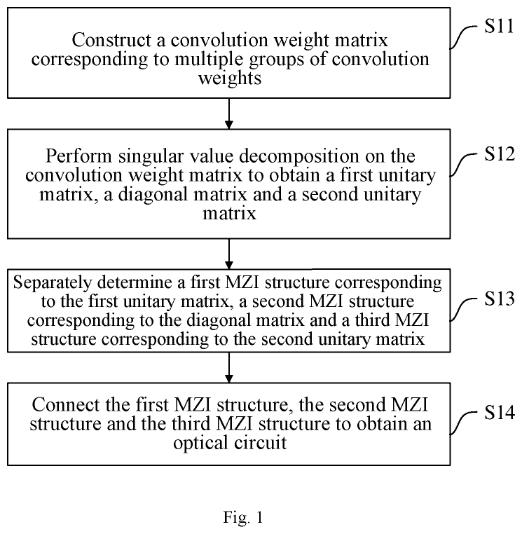

Referring to FIG. 1, an embodiment of this application discloses an optical circuit building method. The method includes the following steps.

Step S11: Construct a convolution weight matrix corresponding to multiple groups of convolution weights.

In a specific implementation, the convolution weight matrix is constructed by using each group of convolution weights as each row data of the convolution weight matrix, where each column data of the convolution weight matrix corresponds to a corresponding row data in a convolution multiplicand sequence.

A CNN for image processing is used as an example. A convolution operation is shown as follows:

$$[ \begin{matrix}0.1 & 0.3 \\ 0.3 & 0.4\end{matrix} ] ⊗ [ \text{} \begin{matrix}1 & 2 & 3 \\ 4 & 5 & 6 \\ 7 & 8 & 9\end{matrix} ] = [ \text{} \begin{matrix}{0.1}^{*} 1 + {0.2}^{*} 2 + {0.3}^{*} 4 + {0.4}^{*} 5 & {0.1}^{*} 2 + {0.2}^{*} 3 + {0.3}^{*} 4 + {0.4}^{*} 6 \\ {0.1}^{*} 4 + {0.2}^{*} 5 + {0.3}^{*} 7 + {0.4}^{*} 8 & {0.1}^{*} 5 + {0.2}^{*} 6 + {0.3}^{*} 8 + {0.4}^{*} 9\end{matrix} ] ;$$

It needs to be pointed out that a forward propagation process of an ANN strongly depends on multiply-add operations. Most operations in an inference process of the forward propagation process are essentially linear operations between trained weights and feature values. An implementation principle of matrix multiplication calculation using an optical chip for is greatly different from that using an electrical chip. In a digital integrated circuit, data is usually encoded into binary strings by using on and off states of transistors. Numbers represented by binary strings are discrete, for example, integer or floating-point values. In optics, data is encoded by modulating amplitudes (or phases) of laser pulses. Consecutive real number values are generated. Represented real numbers are changed by changing intensities or phases of optical fields. In the circuit, electrons may be guided through wires. In optics, laser light may be transmitted through a silicon-based optical waveguide structure.

In a mathematical model, by using structures such as a programmable phase shifter and an MZI, matrix multiplication operations in any dimension may be implemented in optical domain in an SVD manner. In linear algebra, SVD is an important matrix decomposition manner, is also one of the algorithms commonly used in machine learning, and is widely used in feature extraction, data reduction, and recommendation systems. A real number matrix in any dimension may be mathematically converted into a product of three matrices through decomposition by using an SVD method. It is set that M is an m*m matrix. U is an m*m matrix, is a unitary matrix, and is an m*m diagonal matrix. Values on a diagonal are non-negative real numbers. V is an m*m matrix, and is also a unitary matrix. V* is used to represent a complex conjugate matrix of V. SVD on the matrix M may be represented by a formula M=UΣV*.

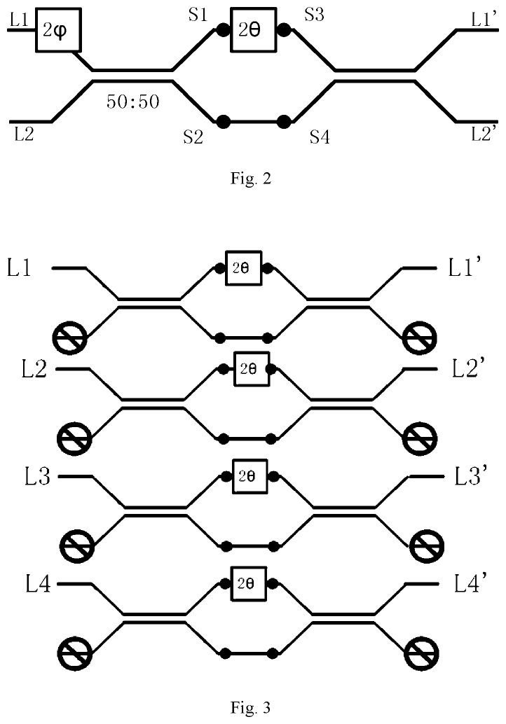

For example, referring to FIG. 2, FIG. 2 is a schematic structural diagram of a specific MZI according to an embodiment of this application. In FIG. 2, L1 and L2 are optical input terminals of the MZI. Outputted light is L1′ and L2′. The MZI may couple optical power of a pair of ports to another pair of ports according to a specific ratio, and a split ratio is 50:50. S1, S2, S3, and S4 represent intermediate states. 2ϕ is an adjustment value of the spit arm. 2θ is a phase shift angle of a phase shifter, and has a programmable function. A programmable phase shifter may usually be implemented in several manners. For example, a metal film is plated on a section of waveguide material. An external voltage is applied to control a metal film heater to cause a temperature change in a waveguide to change a refractive index, to implement a phase shift. In addition, a phase shift may be introduced by changing the refractive index of the waveguide by using a plasma dispersion effect (changing concentrations of electrons and holes) and an electro-optic effect. If the spit ratio of the MZI in normal production meets 50:50, 2ϕ may be not adjusted, and operation requirements are met only through 20. However, when there is an error in the spit ratio or aspects such as power consumption need to be adjusted, the adjustment of 2ϕ needs to be considered. In consideration of expression manners of L1 and L2, it is set that A is an amplitude, ω is a frequency, t is a time, and 0₁ and 0₂ are initial phases. It may be obtained that:

$$\{ \begin{matrix}L 1 = {A}_{1} cos ( ω t + {θ}_{1} ) \\ L 2 = {A}_{2} cos ( ω t + {θ}_{2} )\end{matrix}$$

In optical-to-electrical conversion, only a real part of light may be recognized, and an imaginary part represents an energy loss in a transmission process. Therefore, the foregoing formula may be further converted into by using a Euler's formula:

$$\{ \begin{matrix}L 1 = Re ( {A}_{1} cos {θ}_{1} + {jA}_{1} sin {θ}_{1} ) = Re ( {A}_{1} {e}^{j {θ}_{1}} ) = Re ( {L}_{1}^{c} ) = {A}_{1} cos {θ}_{1} \\ L 2 = Re ( {A}_{2} cos {θ}_{2} + {jA}_{2} sin {θ}_{2} ) = Re ( {A}_{2} {e}^{j {θ}_{2}} ) = Re ( {L}_{2}^{c} ) = {A}_{2} cos {θ}_{2}\end{matrix}$$

Re in the foregoing formula represents the real part. After L1 and L2 enter the MZI, it may be known that energy in the light is transferred through a coupler to outputted optical signals corresponding to two ports. Therefore, amplitudes of L1 and L2 are

$$\frac{1}{\sqrt{2}}$$

of original amplitudes of L1 and L2. Therefore, a relationship in FIG. 2 may be represented by using the formula:

$$\begin{matrix}[ \begin{matrix}{L}_{1}^{c ′} \\ {L}_{2}^{c ′}\end{matrix} ] = [ \begin{matrix}{e}^{i ϕ} cos θ & - {e}^{i ϕ} sin θ \\ sin θ & cos θ\end{matrix} ] [ \begin{matrix}{L}_{1}^{c} \\ {L}_{2}^{c}\end{matrix} ] \\ = T [ \begin{matrix}{L}_{1}^{c} \\ {L}_{2}^{c}\end{matrix} ]\end{matrix}$$

It is considered that in the forgoing CNN example of image processing, in a front part of an equal sign in the formula, a 3×3 matrix on the right is converted into is a multiplicand sequence of a convolution kernel operation on the right, which may be represented as:

$$[ \begin{matrix}1 & 2 & 3 & 4 \\ 2 & 3 & 5 & 6 \\ 4 & 5 & 7 & 8 \\ 5 & 6 & 8 & 9\end{matrix} ]$$

Convolution kernel weight values in the formula need to be mapped to 2ϕ and 20:

$$[ \begin{matrix}0.1 & 0.2 \\ 0.3 & 0.4\end{matrix} ]$$

In this way, data correspondence of a weight value corresponding to one convolution kernel in a convolution operation is implemented. In an actual ANN, the same set of convolution kernels usually has different weight operation requirements. For example, in addition to the forgoing convolution kernel weight values, convolution operations corresponding to other weight values of the same set of data such as the forgoing multiplicand sequence may be required. For example, all convolution weight values required for operations of the same set of data are shown as follows:

$$\{ \begin{matrix}[ \begin{matrix}0.1 & 0.2 \\ 0.3 & 0.4\end{matrix} ] , ( 1 ) \\ [ \begin{matrix}0.5 & 0.6 \\ 0.7 & 0.8\end{matrix} ] , ( 2 ) \\ [ \begin{matrix}0.2 & 0.4 \\ 0.5 & 0.7\end{matrix} ] , ( 3 ) \\ [ \begin{matrix}0.2 & 0.3 \\ 0.7 & 0.9\end{matrix} ] , ( 4 )\end{matrix}$$

Groups (1), (2), (3), and (4) of convolution weights are included. Therefore, an MZI link method for executing operations of multiple groups of convolution weight values for the same set of inputs in parallel and obtaining different outputted results in parallel needs to be implemented. Convolution weight values that require operations are first extended into a matrix structure shown as follows:

$$[ \begin{matrix}0.1 & 0.2 & 0.3 & 0.4 \\ 0.5 & 0.6 & 0.7 & 0.8 \\ 0.2 & 0.4 & 0.5 & 0.7 \\ 0.2 & 0.3 & 0.7 & 0.9\end{matrix} ]$$

In the formula, each row corresponds to weight values of one group of convolution operations, and each column corresponds to one piece of inputted multiplicand data (that is, one row of data of a multiplicand sequence). In consideration of an operation structure implemented by the MZI, it is set that input data is L1, L2, L3, and L4, which separately represent the first row of data, the second row of data, the third row of data, and the fourth row of data of the convolution multiplicand sequence. The forgoing convolution operation structure that needs to be implemented is:

$$T * L = [ \begin{matrix}0.1 & 0.2 & 0.3 & 0.4 \\ 0.5 & 0.6 & 0.7 & 0.8 \\ 0.2 & 0.4 & 0.5 & 0.7 \\ 0.2 & 0.3 & 0.7 & 0.9\end{matrix} ] * [ \begin{matrix}{∠}_{1} \\ {L}_{2} \\ {L}_{3} \\ {L}_{4}\end{matrix} ]$$

The matrix T is a matrix relationship that needs to be implemented by using different MZI link topology structures.

Step S12: Perform SVD on the convolution weight matrix to obtain a first unitary matrix, a diagonal matrix and a second unitary matrix.

As may be known from the foregoing content, SVD may be performed on any m*n matrix, to obtain two unitary matrices and one diagonal matrix through decomposition. The weight values in the foregoing matrix T are used as an example. SVD may be performed to obtain:

$$[ \begin{matrix}U & V & W\end{matrix} ] = svd ( T )$$

$$U = [ \begin{matrix}- 0.262738576121593 & 0.13891512095894 & - 0.262204629335852 & - 0.918106618068523 \\ - 0.62648616977136 & - 0.7242403796956454 & 0.28781043138387 & - 0.012494282251434 \\ - 0.465408121857439 & 0.078753559519244 & - 0.798693486403119 & 0.373204865656131 \\ - 0.567343634679857 & 0.670802756739378 & 0.458805626293651 & 0.132824165799715\end{matrix} ]$$

$$V = [ \begin{matrix}0.276419018223319 & 0 & 0 & 0 \\ 0 & 0.299580842765848 & 0 & 0 \\ 0 & 0 & 0.093208290081994 & 0 \\ 0 & 0 & 0 & 0.006898845425222\end{matrix} ]$$

$$W = [ \begin{matrix}- 0.262985114763867 & - 0.661982964830674 & 0.533291413164315 & 0.456308724803542 \\ - 0.3779611674457 & - 0.580874768860257 & - 0.660782143474797 & - 0.288264186364014 \\ - 0.552492770877605 & 0.145686818871339 & 0.478746132266724 & - 0.666580250063553 \\ - 0.694792000129324 & 0.450708784008791 & - 0.223090493633668 & 0.514155910423966\end{matrix} ]$$

It may be known that U and W in the formula are unitary matrices, and V is a diagonal matrix. It may be known that U and W in the formula are unitary matrices, and V is a diagonal matrix. U, V, and W are separately decomposed to attempt to construct a topology structure implementation using an MZI. In this embodiment of this application, U is the first unitary matrix, and W is the second unitary matrix.

Step S13: Separately determine a first MZI structure corresponding to the first unitary matrix, a second MZI structure corresponding to the diagonal matrix and a third MZI structure corresponding to the second unitary matrix.

In a specific implementation, a corresponding elimination matrix may be constructed based on an MZI minimum multiply-add unit, and Gaussian elimination may be performed on the first unitary matrix by using the elimination matrix to obtain a diagonal matrix corresponding to the first unitary matrix; and the first MZI structure corresponding to the first unitary matrix may be determined based on the elimination matrix.

In one embodiment of the present application, the MZI minimum multiply-add unit is:

$$R = [ \begin{matrix}cos θ & - sin θ \\ sin θ & cos θ\end{matrix} ] ;$$

where 20 is an MZI phase shift angle.

On condition that any group of convolution weights are weights corresponding to 2×2 convolution and a quantity of groups is 4, the step of constructing a corresponding elimination matrix based on an MZI minimum multiply-add unit includes:
sequentially constructing elimination matrices R_{full 1}, R₁, R_{full 2}, and R₂ based on the MZI minimum multiply-add unit, where

$${R}_{full 1} = [ \begin{matrix}cos {θ}_{14} & 0 & 0 & - sin {θ}_{14} \\ 0 & cos {θ}_{23} & - s in {θ}_{23} & 0 \\ 0 & sin {θ}_{23} & cos {θ}_{23} & 0 \\ sin {θ}_{14} & 0 & 0 & cos {θ}_{14}\end{matrix} ] ;$$

$${R}_{1} = [ \begin{matrix}cos {θ}_{12} & - sin {θ}_{12} & 0 & 0 \\ sin {θ}_{12} & cos {θ}_{12} & 0 & 0 \\ 0 & 0 & 1 & 0 \\ 0 & 0 & 0 & 1\end{matrix} ] ;$$

$${R}_{full 2} = [ \begin{matrix}cos {θ}_{13} & 0 & - sin {θ}_{13} & 0 \\ 0 & c o s {θ}_{24} & 0 & - sin {θ}_{24} \\ sin {θ}_{13} & 0 & cos {θ}_{13} & 0 \\ 0 & sin {θ}_{24} & 0 & cos {θ}_{24}\end{matrix} ] ;$$

$${R}_{2} = [ \begin{matrix}1 & 0 & 0 & 0 \\ 0 & 1 & 0 & 0 \\ 0 & 0 & cos {θ}_{34} & - s in {θ}_{34} \\ 0 & 0 & sin {θ}_{34} & cos {θ}_{34}\end{matrix} ] ;$$

where a subscript 14 of θ₁₄ represents that an input of a corresponding MZI is a first path signal and a fourth path signal corresponding to a convolution multiplicand sequence, a subscript 23 of θ₂₃ represents that an input of a corresponding MZI is a second path signal and a third path signal corresponding to the convolution multiplicand sequence, a subscript 12 of 0₁₂ represents that an input of a corresponding MZI is a first path signal and a second path signal outputted by an MZI structure corresponding to R_{full 1}, a subscript 13 of θ₁₃ represents that an input of a corresponding MZI is a first path signal and a third path signal outputted by an MZI structure corresponding to R₁, a subscript 24 of θ₂₄ represents that an input of a corresponding MZI is a second path signal and a fourth path signal outputted by an MZI structure corresponding to R₁, and a subscript 34 of θ₃₄ represents that an input of a corresponding MZI is a third path signal and a fourth path signal outputted by an MZI structure corresponding to R_{full 2}. That is, four rows of data of the convolution multiplicand sequence are separately converted into is four paths of optical signals to obtain four paths of optical signals carrying corresponding rows of data of the convolution multiplicand sequence. The optical signals are first inputted to the MZI structure corresponding to R_{full 1}, and are then sequentially processed by the MZI structures corresponding to R₁, R_{full 2}, and R₂.

It needs to be pointed out that in consideration of the characteristic of a unitary matrix, an MZI structure of the first unitary matrix is the same as that of the second unitary matrix. In addition, the second MZI structure may be directly determined according to a diagonal matrix.

Specifically, the foregoing SVD result of the matrix T is used as an example:

In consideration of the characteristics of the MZI in the foregoing formula:

$$\begin{matrix}[ \begin{matrix}{L}_{1}^{c ′} \\ {L}_{2}^{c ′}\end{matrix} ] = [ \begin{matrix}{e}^{i ϕ} cos θ & - {e}^{i ϕ} cos θ \\ sin θ & cos θ\end{matrix} ] [ \begin{matrix}{L}_{1}^{c} \\ {L}_{2}^{c}\end{matrix} ] \\ = T [ \begin{matrix}{L}_{1}^{c} \\ {L}_{2}^{c}\end{matrix} ]\end{matrix}$$

Phase modulators of the MZI are separately set. To facilitate deduction, a phase modulator 2ϕ=0 is first set. In this case, only an external phase modulator 20 needs to be adjusted. The MZI minimum multiply-add unit is improved as:

$$R = [ \begin{matrix}cos θ & - sin θ \\ sin θ & cos θ\end{matrix} ]$$

Referring to FIG. 3, FIG. 3 is a schematic structural diagram of a specific second MZI according to an embodiment of this application. It may be known that the matrix V is used as a diagonal matrix, and may be implemented through an MZI link relationship in FIG. 3.

The value of 0 may be obtained through a multiplication relationship. cos θ=0.276419018223319, and therefore θ=arc cos(0.276419018). In this way, a θ value corresponding to an element value in the first row and first column of the diagonal matrix is determined. Correspondingly, 0 values that need to be configured for values of three elements in the second row and second column, the third row and third column, and the fourth row and fourth column are determined by using a same method.

For the unitary matrices U and W, in consideration of the characteristics of a unitary matrix, because a unitary matrix definitely has full rank, a Gaussian elimination operation may be performed by using a Gaussian elimination method and by using the foregoing minimum multiply-add unit, to obtain a diagonal matrix. In an implementation method, the matrix U is used as an example, which is shown as follows:

$$U = [ \begin{matrix}- 0.262738576121593 & 0.13891512095894 & - 0.262204629335852 & - 0.918106618068523 \\ - 0.62648616977136 & - 0.7242403796956454 & 0.28781043138387 & - 0.012494282251434 \\ - 0.465408121857439 & 0.078753559519244 & - 0.798693486403119 & 0.373204865656131 \\ - 0.567343634679857 & 0.670802756739378 & 0.458805626293651 & 0.132824165799715\end{matrix} ]$$

In a specific implementation, a large combined matrix may be gradually shrunk based on a matrix combination pattern to obtain a diagonal matrix. During an operation of the large combined matrix, because involved operations do not affect each other, parallel operation may be implemented, and an operation depth may be reduced. Then non-diagonal elements are gradually eliminated based on a constructed potential diagonal matrix relationship, until a pure diagonal matrix is eventually obtained. Steps of a specific method are as follows:

(1) According to associative laws of matrix, an associated matrix satisfying a diagonal matrix is constructed:

In consideration of that all data information of the matrix U is not equal to 0, elimination needs to be performed. A parallel elimination matrix is first constructed:

$${R}_{full 1} = [ \begin{matrix}cos {θ}_{14} & 0 & 0 & - sin {θ}_{14} \\ 0 & cos {θ}_{23} & - s in {θ}_{23} & 0 \\ 0 & sin {θ}_{23} & cos {θ}_{23} & 0 \\ sin {θ}_{14} & 0 & 0 & cos {θ}_{14}\end{matrix} ] ;$$

According to the characteristics of constructed R_{full 1}, it is first separately considered to perform element elimination on the element in the first row and fourth column and the second row and third column, and operations may be performed in parallel, to obtain:

θ₁₄=a tan(0.918106618068523/0.262738576121953)=1.292071365503776

sin θ₁₄=0.961407021159433; cos θ₁₄=0.275130041371976

θ₂₃=a tan(−0.287810431383870/0.724240379696454)=−0.378259776017395

sin θ₂₃=−0.369303824114208; cos θ₂₃=0.929308713773104
and therefore obtain:

$$U = U * {R}_{full 1} = [ \begin{matrix}- 0.954961424102467 & 0.225928204696166 & - 0.19236716143603 & 0 \\ - 0.184377256489041 & - 0.779332388648279 & 0 & 0.598870649884716 \\ 0.230754022351176 & 0.368146927925663 & - 0.713148825855176 & 0.550126506186561 \\ - 0.28395192102106 & 0.453944174745564 & 0.674102089733021 & 0.581992072023001\end{matrix} ]$$

In this way, a matrix U with two rows containing a zero is constructed. In this case, to continue to perform an operation, combined characteristics of operation multiplication and matrix characteristics of a diagonal matrix that eventually needs to be constructed are considered. In this case, the front two rows of non-diagonal elements all need to be cleared to zero. Therefore, in this case, it is considered to perform elimination on the element in the first row and second column. An elimination matrix is constructed:

$${R}_{1} = [ \begin{matrix}cos {θ}_{12} & - sin {θ}_{12} & 0 & 0 \\ sin {θ}_{12} & cos {θ}_{12} & 0 & 0 \\ 0 & 0 & 1 & 0 \\ 0 & 0 & 0 & 1\end{matrix} ] ;$$

The same operation is performed, to obtain:

74 ₁₂=a tan(−0.225928204696166/0.954961424102467)=−0.232312145977241

sin θ₁₂=−0.230228170981880; cos θ₁₂=0.973136675542721

The matrix U is updated in the same as manner:

$$U = U * {R}_{1} = [ \begin{matrix}- 0.981323022863035 & 0 & - 0.19236716143603 & 0 \\ 0 & - 0.800845768364083 & 0 & 0.598870649884716 \\ 0.139797408310011 & 0.411383354065469 & - 0.713148825855176 & 0.550126506186561 \\ - 0.13214313992319 & 0.435212351951535 & 0.674102089733021 & 0.581992072023001\end{matrix} ]$$

It may be known that in this case, a small matrix constructed by the first row and second row and first column and the second column satisfies a diagonal matrix format required in standards. Therefore, the small matrix needs to be kept. To be specific, other matrix elements other than the small matrix need to be eliminated. The process enters the second step:

(2). The method in (1) is iterated. A parallel elimination matrix is first constructed:

$${R}_{full 2} = [ \begin{matrix}cos {θ}_{13} & 0 & - sin {θ}_{13} & 0 \\ 0 & c o s {θ}_{24} & 0 & - sin {θ}_{24} \\ sin {θ}_{13} & 0 & cos {θ}_{13} & 0 \\ 0 & sin {θ}_{24} & 0 & cos {θ}_{24}\end{matrix} ] ;$$

To eliminate elements other than the diagonal matrix of the combined matrix in (1), in this case, the element in the first row and third column and the element in the second row and fourth column need to be eliminated:

θ₁₃=a tan(0.192367161436030/0.981323022863035)=0.193573793122165

sin θ₁₃=0.192367161436030; cos θ₁₃=0.981323022863035

θ₂₄=a tan(−0.598870649884716/0.800845768364083)=−0.642090167214467

sin θ₂₄=−0.598870649884716; cos θ₂₄=0.800845768364083

Then update is implemented:

$$U = U * {R}_{full 2} = [ \begin{matrix}- 1. & 0 & 0 & 0 \\ 0 & - 1. & 0 & 0 \\ 0. & 0. & - 0.726721792152136 & 0.686931901145367 \\ 1. \times {10}^{- 15} & 0. & 0.686931901145365 & 0.726721792152137\end{matrix} ]$$

It may be known that in this case only the remaining combined matrix at the lower right corer sill does not satisfy the diagonal matrix, and other matrices all meet the diagonal matrix. Therefore, the combined matrix is iterated with reference to (1):

$${R}_{2} = [ \begin{matrix}1 & 0 & 0 & 0 \\ 0 & 1 & 0 & 0 \\ 0 & 0 & cos {θ}_{34} & - s in {θ}_{34} \\ 0 & 0 & sin {θ}_{34} & cos {θ}_{34}\end{matrix} ] ;$$

It may be obtained based on the forgoing operation that:

θ₃₄=a tan(−0.686931901145367/0.726721792152136)=−0.757258748200924

sin θ₃₄=−0.686931901145367; cos θ₃₄=0.726721792152136
to calculate:

$$U = {U}^{*} {R}_{2} = [ \begin{matrix}- 1 & 0 & 0 & 0 \\ 0 & - 1 & 0 & 0 \\ 0 & 0 & - 1 & 0 \\ 0 & 0 & 0 & 1\end{matrix} ]$$

It may be known that the operation is completed. −1 may be adjusted by adjusting θ+π, to change positive and negative values.

As can be seen, MZI construction matrices that may be obtained through intermediate operation steps are R_{full 1}, R₁, R_{full 2}, and R₂, and the diagonal matrix obtained by using the intermediate operation steps may be represented as:

I=U*R_{full 1}*R₁*R_{full 2}*R₂

Therefore, it may be known that the operation of the matrix U may be represented as:

U=I*R₂⁻¹*R_{full 2}⁻¹*R₁⁻¹*R_{full 1}⁻¹

It is further known that all matrices R implemented by using the MZI has distinct unitary matrix characteristics. Therefore, an inverse matrix of a matrix R is a transpose matrix of the matrix R. The matrices do not need to be reversed, and only need to be transposed. In the forgoing construction, R_{full 1}⁻¹ is used as an example:

$${R}_{full 1}^{- 1} = {[ \begin{matrix}cos {θ}_{13} & 0 & - sin {θ}_{13} & o \\ 0 & c o s {θ}_{4} & 0 & - sin {θ}_{24} \\ sin {θ}_{13} & 0 & cos {θ}_{13} & 0 \\ 0 & sin {θ}_{24} & 0 & cos {θ}_{24}\end{matrix} ]}^{- 1} = {R}_{full 1}^{*} = [ \begin{matrix}cos {θ}_{13} & 0 & sin {θ}_{13} & 0 \\ 0 & cos {θ}_{24} & 0 & sin {θ}_{24} \\ - sin {θ}_{13} & 0 & cos {θ}_{13} & 0 \\ 0 & - sin {θ}_{24} & 0 & cos {θ}_{24}\end{matrix} ]$$

According to a trigonometric function relationship, it may be known that in this case, for both θ₁₃ and θ₂₄, θ+π is obtained.

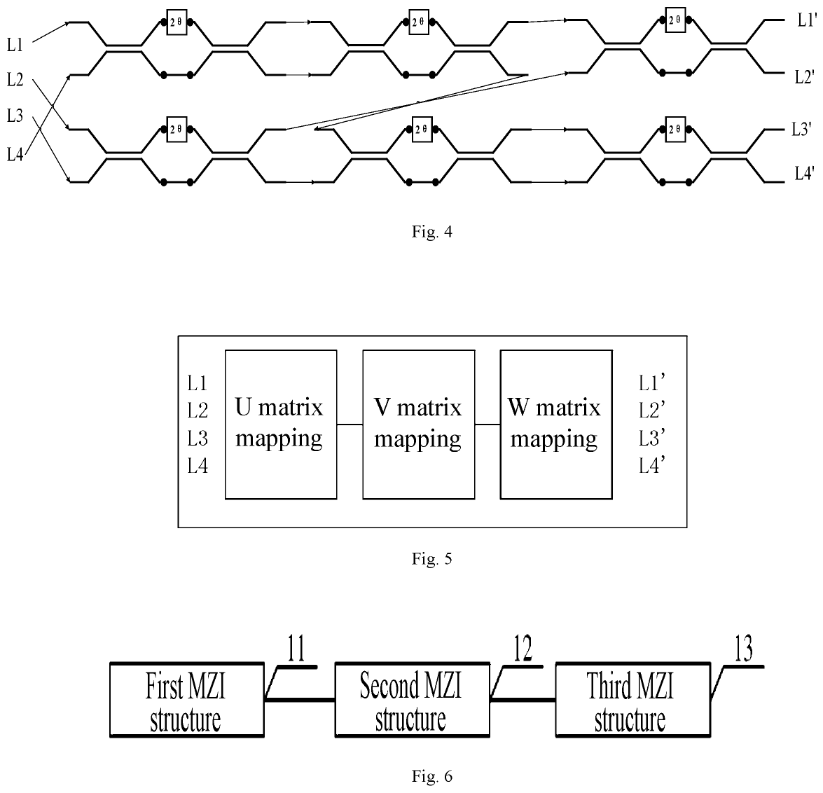

In this way, each elimination matrix is determined, to determine an MZI structure corresponding to a unitary matrix. Matrices U and W in a parallel convolution structure constructed based on an embodiment of this application may be shown in FIG. 4. FIG. 4 is a schematic diagram of an MZI structure corresponding to a specific unitary matrix according to an embodiment of this application.

Step S14: Connect the first MZI structure, the second MZI structure and the third MZI structure to obtain an optical circuit.

In a specific implementation, the first MZI structure, the second MZI structure and the third MZI structure may be sequentially connected to obtain an optical circuit.

Referring to FIG. 5, FIG. 5 is a schematic diagram of a specific optical circuit according to this application. Data L1, data L2, data L3, and data L4 are inputted. L1′, L2′, L3′, and L4′ are respectively convolution operation multiply-add results of four groups of convolution weights in the foregoing example.

It needs to be pointed out that the solution provided in this application is convenient to expand. Any group of convolution weight values may be implemented as different MZI link structures by using this solution after SVD decomposition, and then the MZI link structures are interconnected to obtain corresponding operation results. The obtained results undergo the same depth, and may be obtained at the same time. In a mapping method implemented by using an MZI, MZI devices that can perform operations in parallel are utilized to the maximum based on matrix decomposition patterns, and the method has specific solubility and depth optimality.

As can be seen, in this embodiment of this application, a convolution weight matrix corresponding to multiple groups of convolution weights is constructed. Subsequently, SVD is performed on the convolution weight matrix to obtain a first unitary matrix, a diagonal matrix and a second unitary matrix. Then, a first MZI structure corresponding to the first unitary matrix, a second MZI structure corresponding to the diagonal matrix and a third MZI structure corresponding to the second unitary matrix are separately determined. Finally, the first MZI structure, the second MZI structure and the third MZI structure are connected to obtain an optical circuit. That is, in this application, a convolution weight matrix corresponding to multiple groups of convolution weights is first decomposed to obtain two unitary matrices and one diagonal matrix. Subsequently, MZI structures corresponding to the two unitary matrices and the one diagonal matrix are determined. Finally, the MZI structures are connected to obtain an optical circuit. In an optical circuit obtained by means of the foregoing, convolution calculation processing corresponding to multiple groups of convolution weights may be carried out at the same time, operation depth may be reduced, and operation efficiency may be improved.

Referring to FIG. 6, an embodiment of this application discloses an optical circuit. The optical circuit is built by using the optical circuit building method in the foregoing embodiment, and includes:
a first MZI structure 11 configured to connect to an optical signal;
a second MZI structure 12 connected to the first MZI structure; and
a third MZI structure 13 connected to the second MZI structure, where
the first MZI structure, the second MZI structure and the third MZI structure separately perform phase shifting on their respective input signals, to perform convolution calculation processing corresponding to multiple groups of convolution weights in parallel;
the third MZI structure outputs an optical signal after convolution processing; and
the first MZI structure is an MZI structure corresponding to a first unitary matrix, the second MZI structure is an MZI structure corresponding to a diagonal matrix, the third MZI structure is an MZI structure corresponding to a second unitary matrix, the first unitary matrix, the diagonal matrix and the second unitary matrix are matrices obtained by performing SVD on a convolution weight matrix, and the convolution weight matrix is a weight matrix corresponding to the multiple groups of convolution weights.

It can be seen that the optical circuit disclosed in this embodiment of this application includes a first MZI structure configured to connect to an optical signal, a second MZI structure connected to the first MZI structure, and a third MZI structure connected to the second MZI structure. In addition, the first MZI structure, the second MZI structure and the third MZI structure separately perform phase shifting on their respective input signals, to perform convolution calculation processing corresponding to multiple groups of convolution weights in parallel. The third MZI structure outputs an optical signal after convolution processing. The first MZI structure is an MZI structure corresponding to a first unitary matrix, the second MZI structure is an MZI structure corresponding to a diagonal matrix, the third MZI structure is an MZI structure corresponding to a second unitary matrix, the first unitary matrix, the diagonal matrix and the second unitary matrix are matrices obtained by performing SVD on a convolution weight matrix, and the convolution weight matrix is a weight matrix corresponding to the multiple groups of convolution weights. That is, the first MZI structure, the second MZI structure, and the third MZI structure in this embodiment of this application are determined by unitary matrices and diagonal matrices obtained by performing decomposition based on weight matrices corresponding to multiple groups of convolution weights. In this way, the circuit may carry out convolution calculation processing corresponding to multiple groups of convolution weights at the same time, operation depth may be reduced, and operation efficiency may be improved.

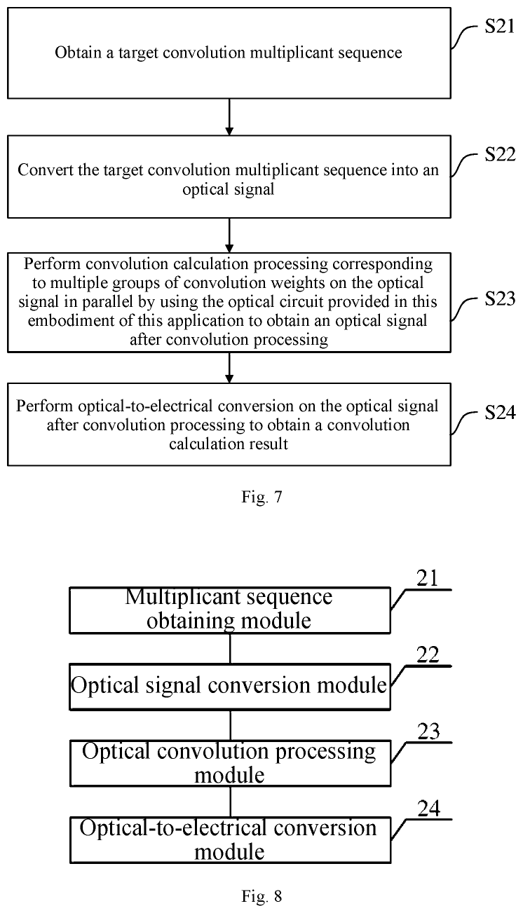

Referring to FIG. 7, an embodiment of this application discloses an optical signal processing method. The method includes the following steps.

Step S21: Obtain a target convolution multiplicand sequence.

Step S22: Convert the target convolution multiplicand sequence into an optical signal.

For example, four rows of data of a convolution multiplicand sequence corresponding to 2×2 convolution are separately converted into four paths of optical signals, which are inputted into the optical circuit provided in this embodiment of this application.

Step S23: Perform convolution calculation processing corresponding to multiple groups of convolution weights on the optical signal in parallel by using the optical circuit provided in this embodiment of this application to obtain an optical signal after convolution processing.

Step S24: Perform optical-to-electrical conversion on the optical signal after convolution processing to obtain a convolution calculation result.

In a specific implementation, all phase shift angle configuration values in the optical circuit may be determined based on a convolution weight matrix corresponding to current multiple groups of convolution weights; and the optical circuit may be configured by using the phase shift angle configuration values. That is, all θ values in the optical circuit are determined. For a specific method for calculating the phase shift angle configuration values, refer to the content disclosed in the foregoing embodiments. Details are not described herein again.

It can be seen that in the signal processing method in this embodiment of this application, by using the foregoing optical circuit, convolution calculation processing corresponding to multiple groups of convolution weights may be carried out at the same time, operation depth may be reduced, and operation efficiency may be improved.

Referring to FIG. 8, an embodiment of this application discloses an optical signal processing apparatus. The apparatus includes:
a multiplicand sequence obtaining module 21, configured to obtain a target convolution multiplicand sequence;
an optical signal conversion module 22, configured to convert the target convolution multiplicand sequence into an optical signal;
an optical convolution processing module 23, configured to perform convolution calculation processing corresponding to multiple groups of convolution weights on the optical signal in parallel by using the optical circuit according to claim 6 to obtain an optical signal after convolution processing; and
an optical-to-electrical conversion module 24, configured to perform optical-to-electrical conversion on the optical signal after convolution processing to obtain a convolution calculation result.

In addition, the optical signal processing apparatus further includes:
a phase shift angle determination module, configured to determine all phase shift angle configuration values in the optical circuit based on a convolution weight matrix corresponding to current multiple groups of convolution weights; and
a phase shift angle configuration module, configured to configure the optical circuit by using the phase shift angle configuration values.

It can be seen that in the signal processing apparatus in this embodiment of this application, by using the foregoing optical circuit, convolution calculation processing corresponding to multiple groups of convolution weights may be carried out at the same time, operation depth may be reduced, and operation efficiency may be improved.

Further, an embodiment of this application further discloses a computer-readable storage medium, configured to store a computer program. The computer program, when executed by a processor, implements the optical signal processing method disclosed in the foregoing embodiments.

For a specific process of the forgoing optical signal processing method, refer to the corresponding content disclosed in the foregoing embodiments. Details are not described herein again.

In order for a person skilled in the art to fully understand the technical effects and practical application value of the technical solutions provided in the embodiments of this application, the current status and prospects of electrical computing and optical computing are briefly described below.

With the development of technology, today's society has entered the era of cloud+AI+5G. In order to meet the computing needs of cloud+AI+5G, there is a need for dedicated chips that support high computing capacity. In 1971, the American Intel Corporation launched the first microprocessor chip 4004 applied to electronic computers. This initiative has had a profound impact on the entire electronics industry. The computer and internet revolution brought about by microprocessor chips has changed the entire world. Chips are one of the greatest inventions of mankind and the foundation and core of the modern electronic information industry. Mobile phones, computers, digital cameras, 5G, internet of things, and cloud computing are all based on the continuous breakthroughs in chip technology. The development of semiconductor lithography process level is the cornerstone of chip-based electronic computers. Current manufacturing process of semiconductor lithography almost reaches the physical limit of Moore's law. As the manufacturing process becomes smaller and smaller, transistor units in chips are close to the molecular scale, and the “bottleneck effect” of semiconductor production process is becoming more and more obvious.

With globalization and the rapid development of science and technology, the amount of data to be processed is increasing dramatically, and corresponding data processing models and algorithms are also increasing, which brings increasingly high requirements for computing power and power consumption. The current von Neumann and Harvard architectures have transmission bottlenecks, increased power consumption, and computing power bottlenecks, making it increasingly difficult to meet the demand for computing power and power consumption in the era of big data. Therefore, it is currently urgent to increase computing speed and reduce power consumption.

The use of photonic computing methods in place of conventional electronic computing methods is one of the most promising ways to solve the Moore's Law dilemma and the problems of the von Neumann architecture, that is, to solve the current computing power and power consumption problems. Photons have the characteristics of light speed propagation, anti-electromagnetic interference, arbitrary superposition, and the like. With the natural parallel computing characteristics, optical computing has very fast computing speed and is very suitable for parallel computing.

The industry is fully confident in optical technology. Optical computing has many advantages over electrical computing. For example, optical signals propagate at the speed of light, so that the speed is greatly increased. Light has natural parallel processing capabilities and mature wavelength division multiplexing technology, so that data processing capability, capacity, and bandwidth are greatly enhanced. Power consumption of optical computing is expected to be as low as 10 J/bit to 18 J/bit. With the same power consumption, photonic devices are hundreds of times faster than electronic devices.

In recent years, the demand for optical computing technology has increased rapidly due to the following reasons: First, with the gradual failure of Moore's Law and the increasing power and speed requirements for computing systems in the era of big data, the high-speed and low-power consumption characteristics of optical computing technology are gaining more and more attention. Second, the parallel computing characteristics of optical computing technology and the development of algorithms and hardware architectures such as ONNs provide the most promising solutions for requirements of image recognition, voice recognition, virtual reality, and other artificial intelligence technologies for computing power. Optical computing may be divided into analog optical computing and digital optical computing. The most typical example of analog optical computing is Fourier operations, which require the use of Fourier transform-related calculations, for example, convolution calculations, in fields such as image processing. It is very computationally intensive to calculate the Fourier transform by using a conventional computer. A process in which light passes through a lens is a Fourier transform process. This process takes almost no time at all. Digital optical computing uses a combination of light and optical devices to form classical logic gates to build a computing system similar to the principle of conventional digital electronic computing, and implements computation through complex combinations of logic gate operations.

In the era of big data, people have increasingly high demand for computing power and speed of electronic computer processing systems. The failure of Moore's law makes electronic chips encounter great challenges in terms of computing speed and power consumption. Photonic computing chips use photons as the carrier of information and have the advantages of high-speed parallelism and low power consumption, and are therefore considered to be the most promising solution for future high-speed, large data volume, and artificial intelligence computing processing.

Photonic chips can solve many key problems in application areas such as long data processing time, inability of real-time processing, and high power consumption. For example, in the ranging, speed measurement, and high-resolution imaging LIDAR of a long-range, high-speed moving target and in novel computational microscopic correlation imaging equipment for high-resolution nondestructive testing of internal structures of biomedical and nano devices, photonic chips can play the advantages of high-speed parallelism, low power consumption, and miniaturization.

All embodiments are described in the present invention by using the progressive method. Each embodiment describes only the difference from other embodiments. For the same or similar parts among all embodiments, reference may be made to the relevant parts. For the apparatus disclosed in the embodiments, because the apparatus corresponds to the method disclosed in the embodiments, the description is relatively simple. For related parts, reference may be made to the description of the method part.

Steps of methods or algorithms described in the embodiments disclosed in this specification may be directly implemented by hardware, a software module executed by a processor, or a combination thereof. The software module may reside in a random access memory (RAM), a memory, a read-only memory (ROM), an electrically programmable ROM, an electrically erasable programmable ROM, a register, a hard disk, a removable disk, a CD-ROM, or any other form of storage medium known in the art.

The optical circuit building method, the optical circuit, and the optical signal processing method and apparatus provided in this application are described above in detail. Although the principle and implementation manners of this application are described by using specific examples in this specification, descriptions of the embodiments are merely intended to help understand the methods and core idea of this application. In addition, for a person of ordinary skill in the art, according to the idea of this application, changes may be made to the specific implementation and the scope of application. In summary, the content of this specification should not be construed as a limitation to this application.

1. An optical circuit building method, comprising:
constructing a convolution weight matrix corresponding to multiple groups of convolution weights;
performing singular value decomposition on the convolution weight matrix to obtain a first unitary matrix, a diagonal matrix and a second unitary matrix;
separately determining a first MZI structure corresponding to the first unitary matrix, a second MZI structure corresponding to the diagonal matrix and a third MZI structure corresponding to the second unitary matrix; and
connecting the first MZI structure, the second MZI structure and the third MZI structure to obtain an optical circuit.

2. The optical circuit building method according to claim 1, wherein the step of constructing a convolution weight matrix corresponding to multiple groups of convolution weights comprises:
constructing the convolution weight matrix by using each group of convolution weights as each row data of the convolution weight matrix, wherein each column data of the convolution weight matrix corresponds to a corresponding row data in a convolution multiplicand sequence.

3. The optical circuit building method according to claim 1, wherein the step of determining a first MZI structure corresponding to the first unitary matrix comprises:
constructing a corresponding elimination matrix based on an MZI minimum multiply-add unit, and performing Gaussian elimination on the first unitary matrix by using the elimination matrix to obtain a diagonal matrix corresponding to the first unitary matrix; and
determining the first MZI structure corresponding to the first unitary matrix based on the elimination matrix.

4. The optical circuit building method according to claim 3, wherein the MZI minimum multiply-add unit is:
$$R = [ \begin{matrix}cos θ & - sin θ \\ sin θ & cos θ\end{matrix} ] ;$$
wherein 2θ is an MZI phase shift angle.

5. The optical circuit building method according to claim 4, wherein in respond to any group of convolution weights are weights corresponding to 2×2 convolution and a quantity of groups is 4, the step of constructing a corresponding elimination matrix based on an MZI minimum multiply-add unit comprises:
sequentially constructing elimination matrices R_{full 1}, R₁, R_{full 2}, and R₂ based on the MZI minimum multiply-add unit, wherein
$${R}_{full 1} = [ \begin{matrix}cos {θ}_{14} & 0 & 0 & - sin {θ}_{14} \\ 0 & cos {θ}_{23} & - s in {θ}_{23} & 0 \\ 0 & sin {θ}_{23} & cos {θ}_{23} & 0 \\ sin {θ}_{14} & 0 & 0 & cos {θ}_{14}\end{matrix} ] ;$$
$${R}_{1} = [ \begin{matrix}cos {θ}_{12} & - sin {θ}_{12} & 0 & 0 \\ sin {θ}_{12} & cos {θ}_{12} & 0 & 0 \\ 0 & 0 & 1 & 0 \\ 0 & 0 & 0 & 1\end{matrix} ] ;$$
$${R}_{full 2} = [ \begin{matrix}cos {θ}_{13} & 0 & - sin {θ}_{13} & 0 \\ 0 & cos {θ}_{24} & 0 & - sin {θ}_{24} \\ sin {θ}_{13} & 0 & cos {θ}_{13} & 0 \\ 0 & sin {θ}_{24} & 0 & cos {θ}_{24}\end{matrix} ] ;$$
$${R}_{2} = [ \begin{matrix}1 & 0 & 0 & 0 \\ 0 & 1 & 0 & 0 \\ 0 & 0 & cos {θ}_{34} & - sin {θ}_{34} \\ 0 & 0 & sin {θ}_{34} & cos {θ}_{34}\end{matrix} ] ;$$
wherein a subscript 14 of θ₁₄ represents that an input of a corresponding MZI is a first path signal and a fourth path signal corresponding to a convolution multiplicand sequence, a subscript 23 of θ₂₃ represents that an input of a corresponding MZI is a second path signal and a third path signal corresponding to the convolution multiplicand sequence, a subscript 12 of θ₁₂ represents that an input of a corresponding MZI is a first path signal and a second path signal outputted by an MZI structure corresponding to R_{full 1}, a subscript 13 of θ₁₃ represents that an input of a corresponding MZI is a first path signal and a third path signal outputted by an MZI structure corresponding to R₁, a subscript 24 of θ₂₄ represents that an input of a corresponding MZI is a second path signal and a fourth path signal outputted by an MZI structure corresponding to R₁, and a subscript 34 of θ₃₄ represents that an input of a corresponding MZI is a third path signal and a fourth path signal outputted by an MZI structure corresponding to R_{full 2}.

6. An optical circuit, wherein the optical circuit is built by using the optical circuit building method according to claim 1, and comprises:
a first MZI structure configured to connect to an optical signal;
a second MZI structure connected to the first MZI structure; and
a third MZI structure connected to the second MZI structure, wherein
the first MZI structure, the second MZI structure and the third MZI structure separately perform phase shifting on their respective input signals, to perform convolution calculation processing corresponding to multiple groups of convolution weights in parallel;
the third MZI structure outputs an optical signal after convolution processing; and
the first MZI structure is an MZI structure corresponding to a first unitary matrix, the second MZI structure is an MZI structure corresponding to a diagonal matrix, the third MZI structure is an MZI structure corresponding to a second unitary matrix, the first unitary matrix, the diagonal matrix and the second unitary matrix are matrices obtained by performing singular value decomposition on a convolution weight matrix, and the convolution weight matrix is a weight matrix corresponding to the multiple groups of convolution weights.

7. An optical signal processing method, comprising:
obtaining a target convolution multiplicand sequence;
converting the target convolution multiplicand sequence into an optical signal;
performing convolution calculation processing corresponding to multiple groups of convolution weights on the optical signal in parallel by using the optical circuit according to claim 6 to obtain an optical signal after convolution processing; and
performing optical-to-electrical conversion on the optical signal after convolution processing to obtain a convolution calculation result.

8. The optical signal processing method according to claim 7, further comprising:
determining all phase shift angle configuration values in the optical circuit based on a convolution weight matrix corresponding to current multiple groups of convolution weights; and
configuring the optical circuit by using the phase shift angle configuration values.

9. (canceled)

10. (canceled)

11. The optical circuit building method according to claim 1, wherein, the first MZI structure is an MZI structure corresponding to a first unitary matrix, the second MZI structure is an MZI structure corresponding to a diagonal matrix, the third MZI structure is an MZI structure corresponding to a second unitary matrix.

12. The optical circuit building method according to claim 1, wherein, an MZI structure of the first MZI structure is the same as that of the third MZI structure.

13. The optical circuit building method according to claim 1, wherein, the second MZI structure is directly determined according to the diagonal matrix.

14. The optical circuit building method according to claim 1, wherein, the first MZI structure, the second MZI structure and the third MZI structure are sequentially connected to obtain the optical circuit.

15. The optical circuit building method according to claim 5, wherein, the diagonal matrix corresponding to the first unitary matrix is I=U*R_{full 1}*R₁*R_{full 2}*R₂, wherein U represents the first unitary matrix, I represents the diagonal matrix corresponding to the first unitary matrix.

16. The optical circuit building method according to claim 3, further comprising:
determining an inverse matrix of the elimination matrix;
wherein, the step of determining the first MZI structure corresponding to the first unitary matrix based on the elimination matrix comprises:
determining the first MZI structure corresponding to the first unitary matrix based on the diagonal matrix corresponding to the first unitary matrix and the inverse matrix of the elimination matrix.

17. The optical signal processing method according to claim 8, wherein, the convolution weight matrix is constructed by using each group of the current multiple groups of convolution weights as each row data of the convolution weight matrix; each column data of the convolution weight matrix corresponds to a corresponding row data in the target convolution multiplicand sequence.

18. The optical signal processing method according to claim 8, further comprising:
performing singular value decomposition on the convolution weight matrix to obtain a first unitary matrix, a diagonal matrix and a second unitary matrix.

19. The optical circuit according to claim 6, wherein, an MZI structure of the first MZI structure is the same as that of the third MZI structure.

20. The optical circuit according to claim 6, wherein, the second MZI structure is directly determined according to the diagonal matrix.

21. The optical circuit according to claim 6, wherein, the convolution weight matrix is constructed in the following way:
constructing the convolution weight matrix by using each group of convolution weights as each row data of the convolution weight matrix, wherein each column data of the convolution weight matrix corresponds to a corresponding row data in a convolution multiplicand sequence.

22. The optical circuit according to claim 6, wherein, all phase shift angle configuration values in the optical circuit are determined based on the convolution weight matrix.
